(19) United States
(12) Patent Application Publication
(10) Pub. No.: US 2002/0002489 A1
(43) Pub. Date: Jan. 3, 2002

(54) Internet-based promotional business model

(76) Inventors: Karl L. Miller, Glendale, CA (US); Kris D. Nickerson, Glendale, CA (US)

Correspondence Address: ALBERT O COTA, 5460 WHITE OAK AVE, SUITE A-331, ENCINO, CA, 91316, US

(21) Appl. No.: 09/813,658

(22) Filed: Mar. 21, 2001

Related U.S. Application Data
(60) Provisional application No. 60/191,039, filed on Mar. 21, 2000.

(51) Int. Cl. G06F 17/60

(52) U.S. Cl. 705/14; 705/10

(57) ABSTRACT

An Internet-based promotional business model (PBM) (10) consisting of an Internet data center (12) connected to one side of a web server (24) via a first switch (14). The other side of the web server (24) is connected to a database (34) via a second switch (16). The PBM (10) functions by enticing a user to play a lotto type game wherein a series of numbers are selected after which the user selects a banner for review, which is chosen from a set of banners, and/or answers a question. If the numbers chosen are selected the user wins a monetary or other type of prize. The PBM (10) can be used with different types of games, and with the number of questions asked varying from one to any number. The specific nature of the questions can also vary, depending on what subject the questions relate to and which banner(s) is/are selected.

### TECHNICAL FIELD

The invention pertains to the general field of Internet-based models, and more particularly to an Internet-based business model which utilizes promotional incentives to induce individuals to answer questions relating to a selected topic.

### BACKGROUND ART

One of the most revolutionary tools for conducting commence has been the computer. Computer based, or Computer-Assisted Commerce (e-commerce) has allowed both merchants and consumers an unprecedented ability to access almost the entire world easily and economically. The means by which this has been accomplished is the Internet, via the World Wide Web (WWW). By use of the Internet, a consumer can search for goods from among a large variety of sources, and a merchant can literally offer their goods and/or services to the entire world. The Internet also provides world-wide communication and the ability for individuals to participate in world-wide events.

The Internet can also be used for gathering data, especially data that relates to people and their propensity to do certain things, go specific places, and/or buy particular items. As a result of the Internet's ability to quickly communicate with a large number of individuals at one time, the data collected from the Internet can be accessed, updated and sorted in a variety of categories. A major difficulty for individuals and businesses that collect data via the Internet, is enticing individuals to respond to questions. One of the most typical obstacles is that people “Don't have the time or don't want to be bothered”, even when the questions can be beneficial to them. A solution to this problem would be to offer an incentive, such as an opportunity to win a prize, to those individuals who are willing to answer one or more questions. In this way the person answering the question(s) is rewarded for participating and helping, and the data collecting company is able to procure the information needed to function. A further extension of this concept would be to ask questions in an “entertaining environment”, such as a game created from the questions and incentives, by use of this method the person answering the question(s) can actually enjoy it, and is likely to be willing to answer other questions in the future.

A search of the prior art did not disclose any patents that read directly on the claims of the instant invention, however the following U.S. patents are considered related:

| PATENT NO. | INVENTOR | ISSUED |
|---|---|---|
| 6,070,145 | Pinsley, D., et al | May 30, 2000 |
| 5,740,035 | Cohen; et al | April 14, 1998 |
| 5,566,291 | Boulton, D., et al | October 15, 1996 |

The U.S. Pat. No. 6,070,145 discloses a method for conducting a survey of users of an information document site located on a computer network. The method includes embedding computer program instructions into an information document located at the site, where the instructions invoke a survey program. The survey program begins when a user accesses the information document and activates the survey according to offering criteria based upon either a random or systematic participant selection. The method selects a survey participant from the users of the information document and then offers the participant an opportunity to access the survey.

The U.S. Pat. No. 5,740,035 discloses a self-administered survey system and device. The device includes a display, an input device, a memory and a control which controls the display to show at least one survey question and control the memory to store a response to the question(s). The system utilizes a centralized survey data processor and a plurality of the self-administered survey devices for storing survey data entered by respective respondents. The survey data is wirelessly transmitted from the plurality of self-administered survey devices to the centralized survey data processor.

The U.S. Pat. No. 5,566,291 discloses a method and apparatus for implementing user feedback. A user may activate an enter feedback mode command in a computer environment to provide feedback in a feedback interface. A feedback record is created and the user's context within a product, process, service, or issue to which the feedback refers is recorded in the feedback record. Attribute icons that the user may select to identify the nature of the feedback are displayed in the feedback interface. Selected attributes, the time at which the feedback is made, the physical location and identity of the user, and comments by the user are recorded in the feedback record. A feedback visualizer for a reviewer for organizing and presenting user feedback receives the feedback from the users, the feedback is then collected and stored in a database.

For background purposes and as indicative of the art to which the invention relates, reference may be made to the following remaining patents found in the search:

| Patent No. | Inventor | Issue Date |
|---|---|---|
| 6,058,417 | Hess, et al | May 2, 2000 |
| 5,991,756 | Wu | November 23, 1999 |
| 5,800,269 | Holch, et al | September 1, 1998 |
| 5,186,463 | Marin, et al | September 16, 1993 |
| 4,959,783 | Scott, et al | September 25, 1990 |
| 4,665,502 | Kreisner | May 12 1987 |

### DISCLOSURE OF THE INVENTION

In its most basic design, the Internet-based, promotional business model (hereinafter “PBM”) is comprised of the following elements: an Internet data center, which has means for linking worldwide computers with various data and promotional messages. The Internet data center itself is preferably comprised of a redundant, fully-meshed gigabit Ethernet network.

A web server is utilized to allow private or public users of the PBM to view web pages and banners corresponding to a web site selected by the user. In the basic design, a single private web server is utilized, which allows the access to be limited to authorized persons only. The web server has an input and an output, wherein the input is connected, via a first switch to the PBM. A database is connected via a second switch to the web server. The database functions to store a collection of data that is used during operation of the PBM. The final element of the basic design of the PBM comprises a PBM software program, which is written to control the operation of the PBM.

The PBM is designed to function with different types of games and application surveys. The question asked in the survey can vary from one to any number and can vary, depending on the subject matter and the banners selected for viewing. Additionally, the application survey can be served on multiple sites or across several computers on the Internet, a follow-up question can also be served to the same individual at a subsequent or a related site.

In view of the above disclosure, the primary object of the invention is to provide an Internet-based, data collection means, which utilizes a promotional incentive to induce individuals to answer one or more questions.

Another object of the invention is to provide entertainment by means of a lotto, or other game, to Internet users.

Still another object is to offer internet users an opportunity to win cash or other prizes for answering questions and playing a game.

Yet another object is to allow a wide variety of data to be collected by providing questions on a large number of subjects/topics.

Another object is to ask the questions in a survey manner, which can be utilized by companies to determine commercial trends.

Still another object is to provide a service by which individuals or businesses can create a personalized survey for any particular/pertinent need.

Another object of the invention is to provide management and central control of the data collected.

Yet another object of the invention is to create a database for Internet users and their individual buying practices, past or future purchases and personal likes and dislikes.

A final object of the invention is to be able to provide businesses with the names and/or e-mail addresses of potential customers based on the information garnered by the surveys/questions.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram of the basic design for the Internet-based promotional business model (PBM).

FIG. 2 is a block diagram of an enhanced PBM design.

FIGS. 3A and 3B is a block diagram of a PBM utilizing redundant elements.

FIG. 4A is a software diagram of a real-time marketing offer based on a survey response wherein the offer is sent to a user via an e-mail.

FIG. 4B is a software diagram of a real-time marketing offer based on a survey response wherein the user is shown a pop-up.

FIG. 4C is a software diagram of a real-time marketing offer based on a survey response wherein the user is shown a flash/HTML

FIG. 4D is a software diagram of a real-time marketing offer based on a survey response wherein the user is shown a banner.

FIG. 4E is a software diagram of a sequential drill-down group survey.

FIG. 4F is a software diagram of a sequential general non-group survey.

FIG. 4G is a software diagram of a non-sequential drill-down group survey.

FIG. 5 is a display of an IMUSTLOTTO.COM web page.

FIG. 6A is also a display of an IMUSTLOTTO.COM web page.

FIG. 6B is a display of several advertising banners pertaining to a category chosen in FIG. 6A.

FIG. 6C is a display of the lotto numbers selected, an indication of the numbers have won a prize and the advertiser's splash page.

FIG. 6D is a display of an IMUSTLOTTO.COM web page with a set of lotto numbers, a quick-pick option and a question.

FIG. 7A is a display of a first set of lotto numbers, a quick-pick option and a list of survey category banners.

FIG. 7B is a display a second set of lotto numbers, a quick-pick option and a first refinement category.

FIG. 7C is a display of a third set of lotto numbers, a quick-pick option and a second refinement category.

FIG. 7D is a display of the home page pertaining to the second refinement category.

### BEST MODE FOR CARRYING OUT THE INVENTION

The best mode for carrying out the Internet-based promotional business model, (hereinafter “PBM 10”), is presented in terms of a preferred embodiment which is disclosed as a basic serial design, an enhanced serial design and a redundant design. All PBM designs are controlled and operated by a PBM software program.

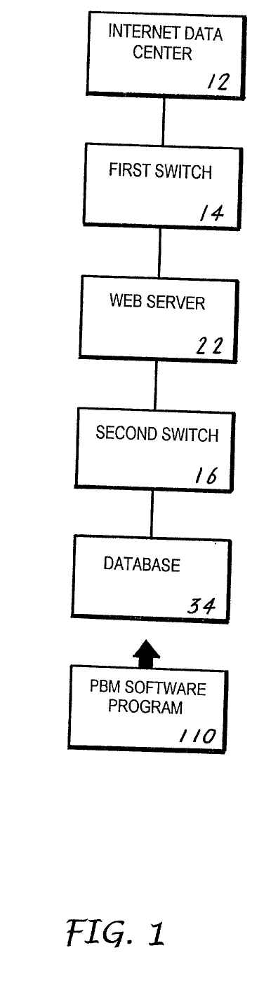

The basic serial design of the PBM, as shown in FIG. 1, is comprised of six major elements: an Internet data center 12, a first switch 14, a web server 22, a second switch 16, a database 34 and a PBM software program 110.

The Internet data center 12 includes means for linking worldwide computers with various data and promotional messages. The Internet utilized for the PBM is comprised of a redundant, fully-meshed gigabit Ethernet network.

The first web server 24, as shown in FIG. 1, is connected to the Internet data center 12 via the first switch 14 and to the database 34 via the second switch 34. The first web server 24 allows both private and public users of the PBM 10 to view web pages corresponding to a web site selected by the user. The database 34 stores a collection of data used in operating the PBM 10.

The PBM software program 110 can be written in various languages including Structured Query Language (SQL) which allows large databases to be easily manipulated; Hypertext Markup Language (HTML) which allows a set of codes to be inserted into text files to indicate special typefaces, images and links to other hypertext documents; JavaScript which allows a web page to include commands to be executed by the web server; Java which allows networked computers to transmit computations as well as data to each other; C++ which is an object-oriented programming language; and VBScript which allows the addition of executable commands to a web page using a language based on Visual BASIC.

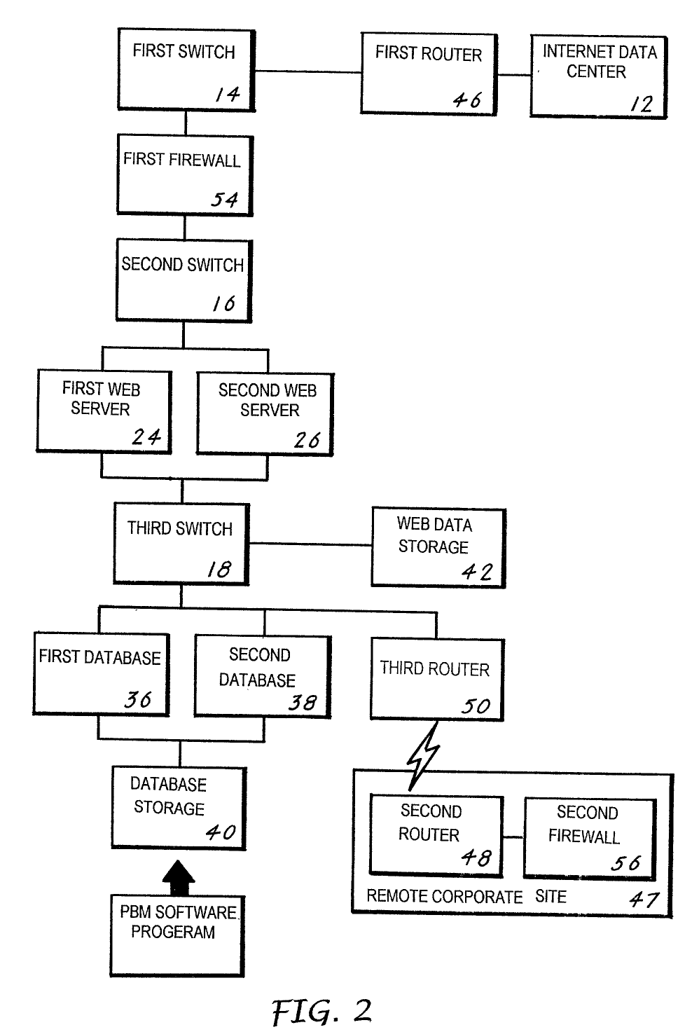

The enhanced serial design of the PBM, as shown in FIG. 2, is comprised of the following major elements: an Internet data center 12, a first switch 14, a second switch 16, a third switch 18, a first web server 24, a second web server 26, a first database 36, a second database 38, a database storage 40, a web data storage 42, a first router 46, a first firewall 54, a remote corporate site 47 consisting of a second router 48 and a second firewall 56, a third router 50, and a PBM software program 110.

The Internet data center has the means for linking worldwide computers with various data and promotional messages. The first router 46 has an input and an output, with the input connected to the Internet data center 12. The first router 46 provides users with controlled access to incoming data packets from the Internet data center 12.

The first firewall 54, as shown in FIG. 2, has an input and an output. The input is connected, via a first switch 14, to the output of the first router 46. The output of the first firewall 54 is connected, via a second switch 16, to the inputs of the first web server 24 and the second web server 26. The first web server 24 allows private or public users of the PBM 10 to view web pages corresponding to a web site selected by the user. The second web server 26 is connected in parallel which allows redundant operation and additional traffic. The inputs to the first and second web severs 24, 26 are connected, via the second switch 16 to the output of the first firewall 54. The first firewall 54 is designed to relay only data packets which are intended and authorized to reach the first and second web servers 24, 26.

The first database 36 in a preferred architecture operates in a cluster with the second database 38 as shown in FIG. 2. The first and second inputs of the first and second databases 36, 38 are connected, via a third switch 18, to the outputs of the first and second web servers 24, 26. Both of the servers function by storing a collection of data required to operate the PBM 10. To complete a database cluster, a database storage 40 is connected to the first and second databases 36, 38.

The second design can also be operated with the web data storage 42 that is connected, via the third switch 18 to the first and second web servers 24, 26. The web data storage 42 allows web pages and images to be stored off the web server, thus increasing their utility and performance.

To further enhance the utility of the second design, the remote corporate site 47 can be included. The site 47 includes the second firewall 56 which is connected to the second router 48. The second router 48 is connected via a telephone line or an RF data link to the third router 50 which, in turn, is connected to the third switch 18.

The final element of the second design is the PBM software program which can be prepared in various formats and languages as described supra.

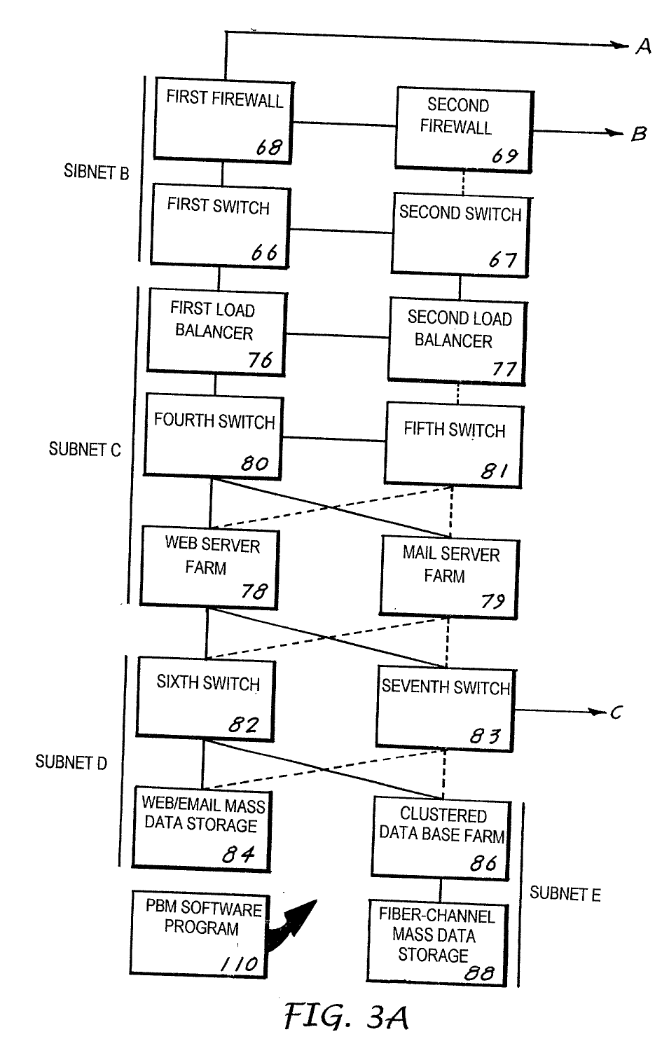

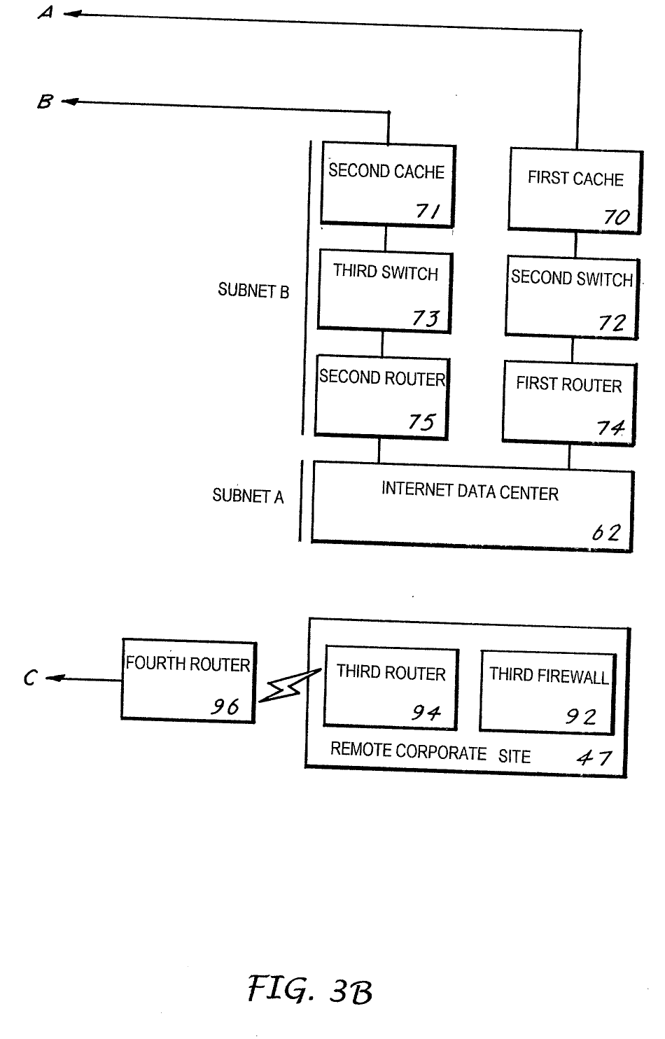

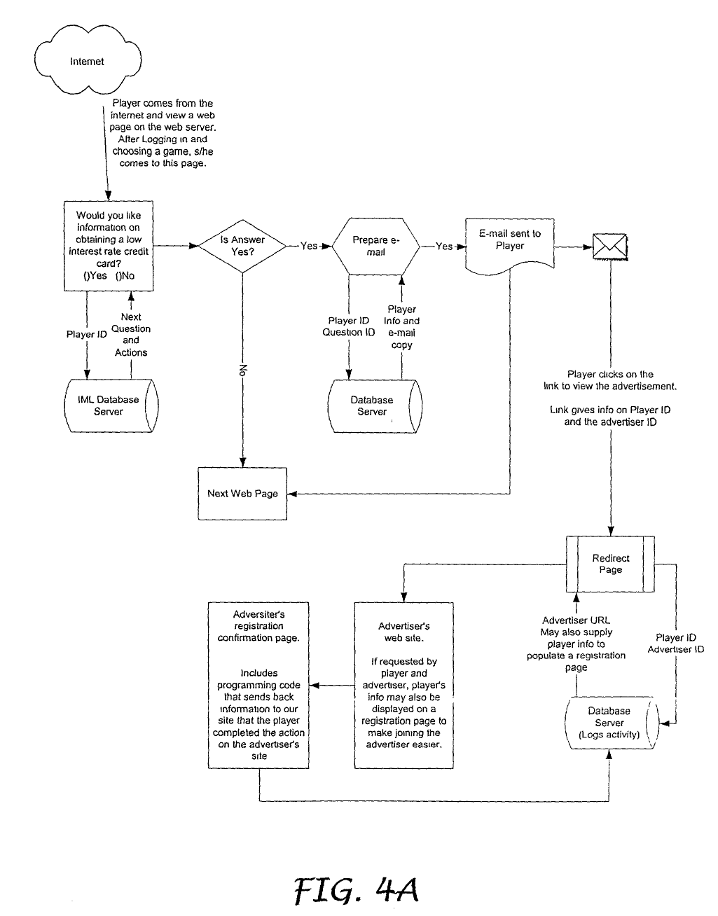

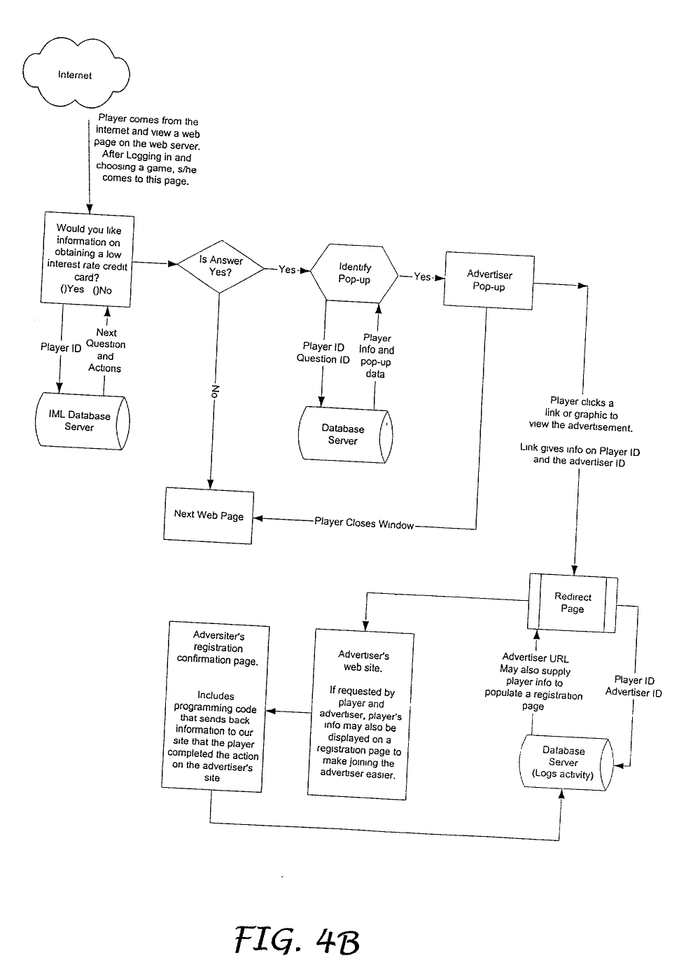

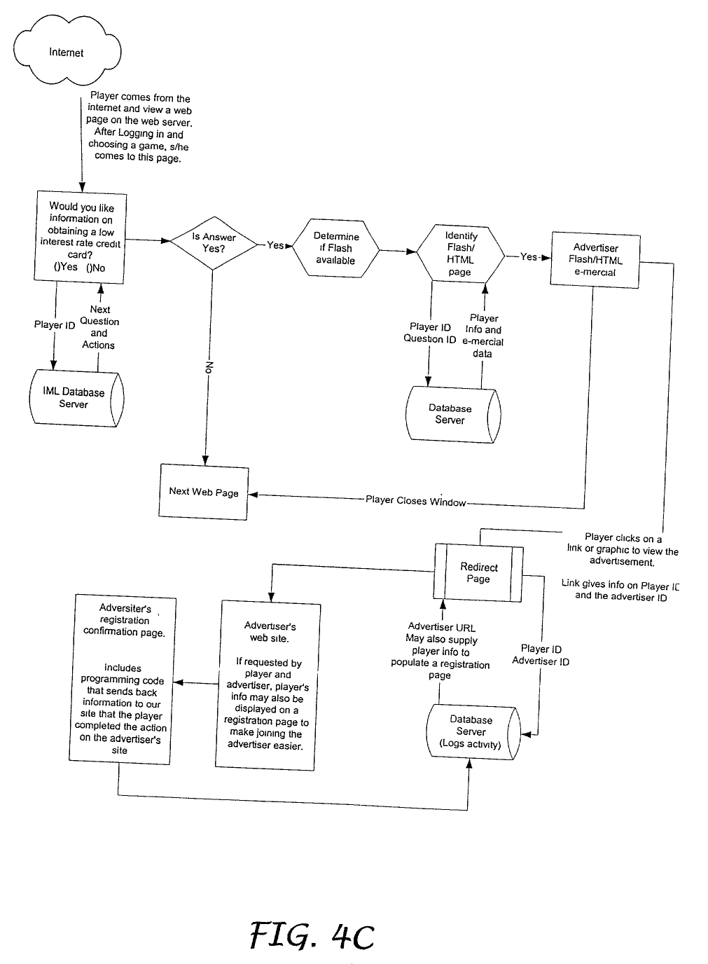

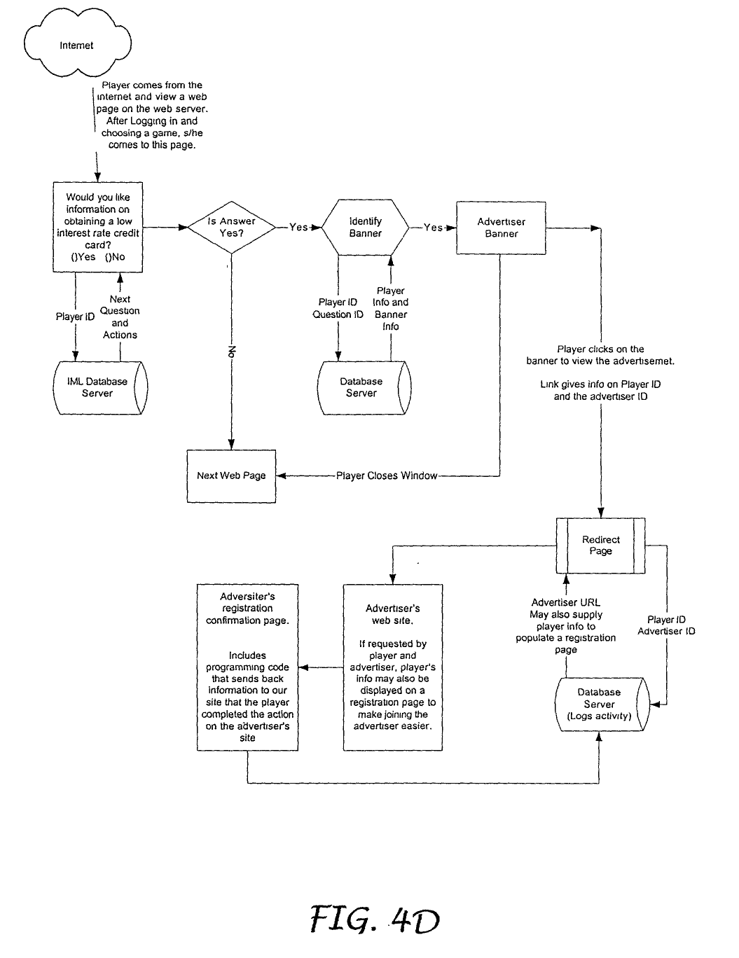

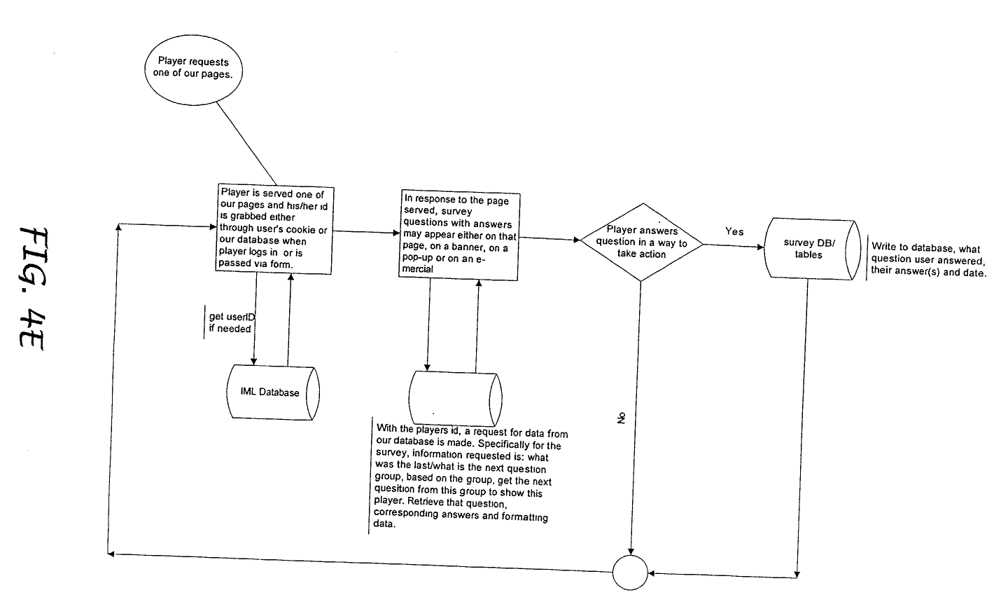

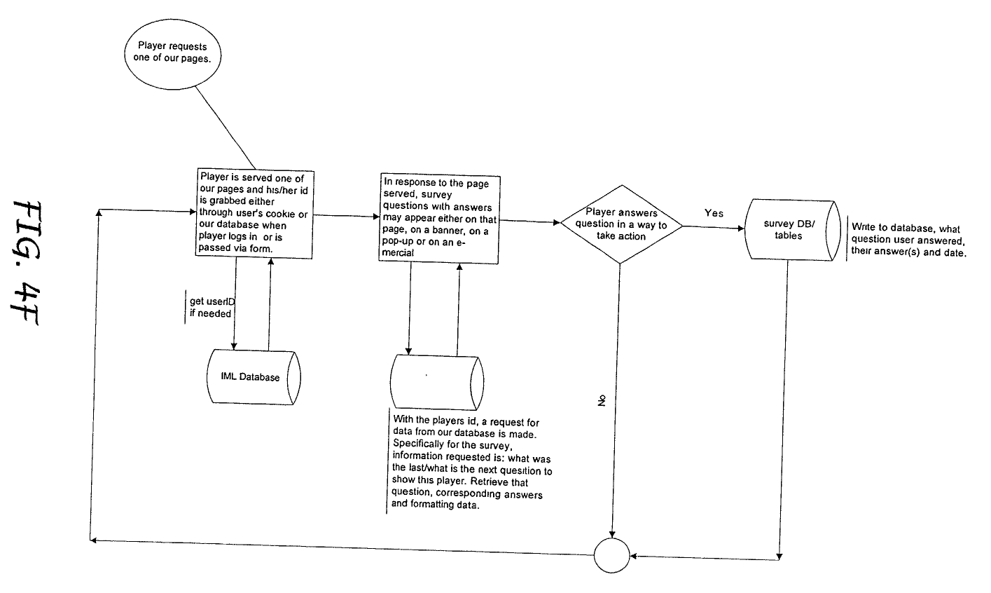

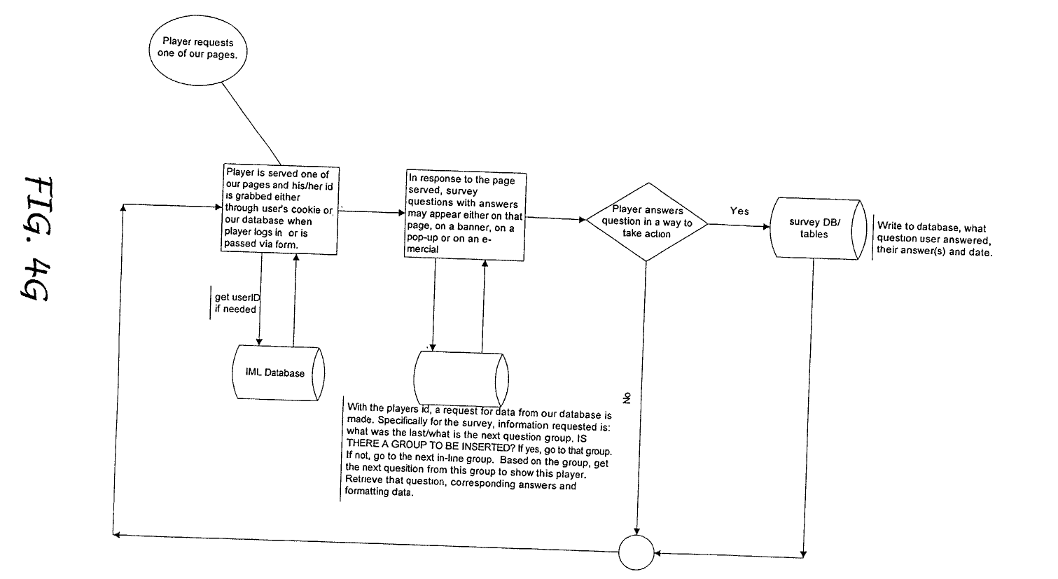

The redundant design of the PBM 10, as shown in FIGS. 3A and 3B is comprised of the following major elements: a subnet A, a subnet B, a subnet C, a subnet D and a subnet E.

The subnet B consists of a first switch 66 and a redundant second switch 67. One side of the first and second switches are connected respectively to a first firewall 68 and a redundant second firewall 69, followed and connected respectively by a first cache server 70 and a redundant second cache server 71. The two cache servers 70, 71 are connected respectively through a second switch 72 and a redundant third switch 73 to a first router 74 and a redundant second router 75 from where the routers are connected to the subnet A which is comprised of a redundant Internet data center 62 as shown in FIG. 3B.

The subnet C, as shown in FIG. 3A, consists of a first load balancer 76 and a redundant second load balancer 77. The two load balancers are connected to subnet B via the first and second switches 66, 67. The two load balancers 76, 77 are also connected to a web server farm 78 and to a mail server farm 79 via a fourth switch 80 and a redundant fifth switch 81. The two switches 80, 81 can connect the web and mail servers 78, 79 either inline with the load balancers or reverse the connections to the load balancers 76, 77.

The subnet D consists of a sixth switch 82 and a redundant seventh switch 83. One side of the switches connects the subnet D to the subnet C and the other side of the switches are connected to a web/E mail mass data storage 84. Either of the two switches 82, 83 can be used to control the operation of the web/E mail mass data storage.

The subnet E consists of a clustered database farm controlled by either the sixth switch 82 or the seventh switch 83. Connected to the clustered database farm 86 is a fiber-channel mass data storage 88.

The function of the subnets A-E is to separate the various elements of the architecture into publically accessible and privately accessible elements.

The redundant design of the PBM 10 is also designed to incorporate a remote private or corporate site 47, which includes a third firewall 92 connected to a third router 94. The third router 92 is connected via a telephone line or an RF data link to a fourth router 96 which is connected to subnet D via the seventh switch 83.

The final structural element applicable to all the PBM 10 designs is the PBM software program, which is comprised of the following passive and interactive modules:

a) a real-time marketing offer based on a survey response, wherein the offer is sent as an e-mail to the user,

b) a real-time marketing offer based on a survey response, wherein the offer is sent to the user via a first pop-up,

c) a real-time marketing offer based on a survey response, wherein the offer is sent to the user via a flash/HTML,

d) a real-time marketing offer based on a survey response, wherein the offer is sent to the user via a banner,

e) a first survey procedure utilizing a sequential, drill-down group survey,

f) a second survey procedure utilizing a sequential, general non-group survey and

g) a third survey procedure utilizing a non-sequential drill-down group survey.

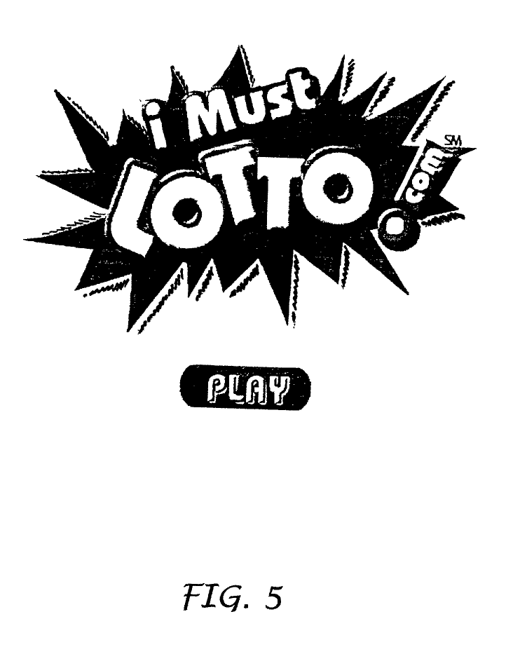

The operation of the PBM 10 is disclosed in two operating modes. In the first operating mode the user logs onto a web site which can be a game site or other inducement/entertainment site. For the purpose of disclosure, the web site will consist of a web page entitled “IMUSTLOTTO.COM”, as shown in FIG. 5, which provides an incentive for participating in a survey, in that a person may select one or more lotto numbers for a chance to win a prize, which is typically money or merchandise, but can be anything of value.

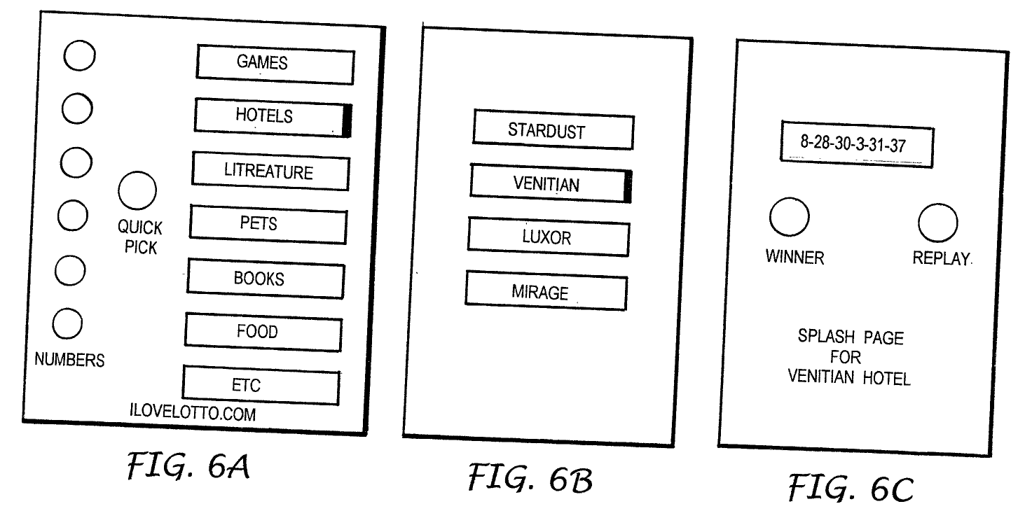

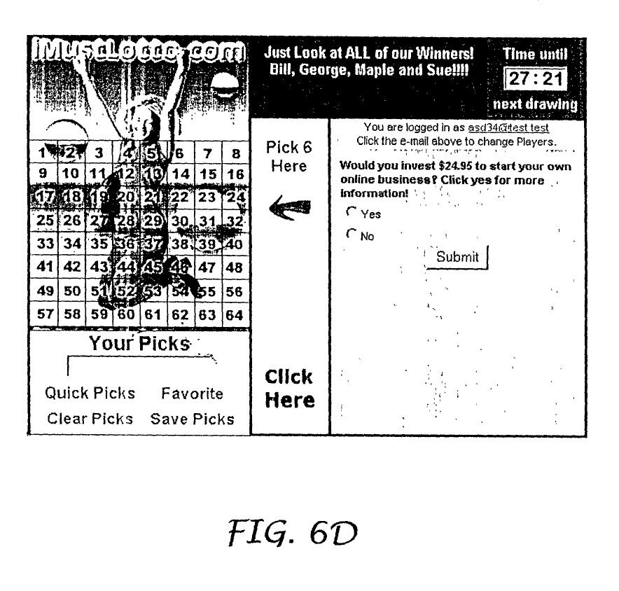

In the first mode, three web pages are sequentially displayed as shown in FIGS. 6A-6C. To commence the operation of the first mode, as shown in FIGS. 6A-6C, the following steps are performed:

1. Log onto the IMUSTLOTTO.COM web page, as shown in FIGS. 6A. and 6D. The web page contains space for entering lotto numbers which may be chosen or “quick-picked” by the computer, and a list of category banners.

2. Select and key-in a set of lotto numbers or select the “quick pick” option as also shown in FIGS. 6A and 6D.

3. Select a single category banner (Example: HOTELS). After the lotto numbers or the “quick pick” and the category banner are selected, a second window appears, as shown in FIG. 6B, that displays several advertising banners pertaining to the category banner selected in step 3.

4. Select a particular advertising banner (Example: VENETIAN). After an advertising banner is selected, a third window appears, as shown in FIG. 6C, that displays:

the lotto numbers selected and indicates if the numbers have won a prize, or the time remaining until the game ends

the advertisers “splash page” showing the details of the advertising banner selected in step 4.

5. Review the contents of the splash page. At this point the participant can log off or continue to a second sequence by clicking a replay button, which allows the PBM software program to return to the IMUSTLOTTO.COM web page where the participant can commence a new sequence of numbers and banners. The number of times a participant can re-enter the IMUSTLOTTO.COM web page is determined by a selection routine embedded in the software program.

In the second operating mode the user logs onto a web page which can consist of any gaming side or other player inducement web page. For the purpose of disclosure, the web page for the second model is also entitled “IMUSTLOTTO.COM” which provides an incentive for the participant in that several lotto games can be selected to potentially win a prize.

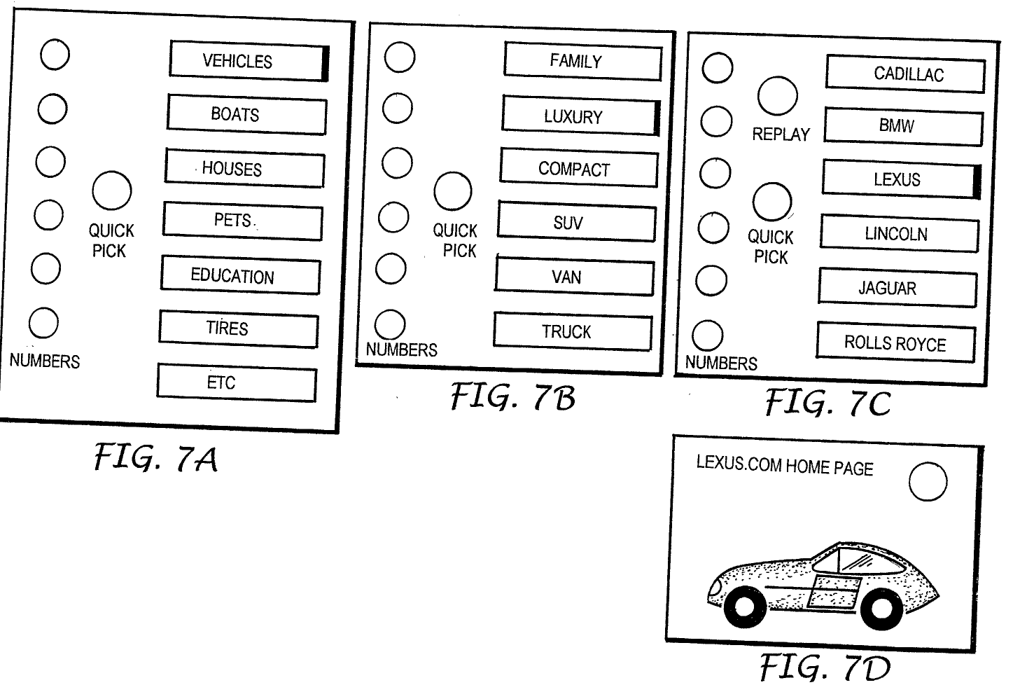

In the second mode, four web pages are sequentially displayed as shown in FIGS. 7A-7D. To commence the second mode of operation, the following steps are performed:

1. Log onto the IMUSTLOTTO.COM web page as shown in FIGS. 5 and 7A. The web page contains numbers which may be chosen, or “quick-picked” by the computer, and a list of survey category banners.

2. Select and key-in a set of lotto numbers or select the “quick pick” option.

3. Select a single category banner (Example: VEHICLES). After the lotto numbers or the “quick pick”, and the single category banner are selected, a second window appears, as shown in FIG. 7B, that has space for entering a second set of lotto numbers or a “quick pick”, and a list of first refinement categories pertaining to the survey category banner selected in step 3.

4. Select a second set of lotto numbers or a “quick pick”, and a first refinement category banner, as shown in FIG. 7B (Example: LUXURY). After the second set of lotto numbers or the “quick pick”, and the first refinement category are selected, a third window appears, as shown in FIG. 7C, that has space for entering a third set of lotto numbers or a “quick pick”, and a list of second refinement categories pertaining to the first refinement category selected in step 4.

5. Select a third set of lotto numbers or a “quick pick”, and a second refinement category banner as shown in FIG. 7C (Example: LEXUS). At this point the participant is notified if any of the lotto numbers selected have won their respective game. After the third set of lotto numbers or the third “quick pick”, and the second refinement category are selected, the home page pertaining to the second refinement category appears which provides data for the various models produced by the company in this example: LEXUS.

6. Review the contents of the home page. At this point, the participant can log off or continue to a second sequence by clicking a replay button, which causes the software program to return to the IMUSTLOTTO.COM web page where the participant can commence a new sequence. The number of times a participant can re-enter the IMUSTLOTTO.COM web page is determined by a selection routine embedded in the software program.

While the invention has been described in complete detail and pictorially shown in the accompanying drawings, it is not to be limited to such details, since many changes and modifications may be made in the invention without departing from the spirit and scope thereof. For example, the disclosure is presented in terms of a lotto site, however, the program can also be used with various other gaming sites or other types of sites. Also, the “banner” referred to in the disclosure refers to any type of HTML link. Hence, it is described to cover any and all modifications and forms which may come within the language and scope of the appended claims.

1. An Internet-based promotional business model (PBM) comprising:
a) an Internet data center having means for linking worldwide computers with various data and promotional messages,
b) a web server having an input and an output, wherein the input is connected, via a first switch, to said Internet data center, wherein said web server allows private or public users of the PBM to view web pages corresponding to a web site selected by the user,
c) a database connected, via a second switch, to said web server, wherein said database stores a collection of data used in operating said PBM, and
d) a PBM software program written to control the operation of said PBM.

2. The PBM as specified in claim 1 wherein said internet data center is further comprised of a redundant, fully-meshed gigabit Ethernet network.

3. The PBM as specified in claim 1 wherein said first and second switches provide the means for respectively routing and controlling the operation of said Internet data center, said web server and said database.

4. An internet-based promotional business model (PBM) comprising:
a) an internet data center having means for linking worldwide computers with various data and promotional messages,
b) a first router having an input and an output, wherein the input is connected to said internet data center, wherein said first router provides users with controlled access to incoming data packets from said internet data center,
c) a first firewall having an input and an output, wherein the input is connected, via a first switch, to the output of said first router,
d) a first web server having an input and an output, wherein said first web server allows private or public users of said PBM to view web pages corresponding to a web site selected by the user,
e) a second web server connected in parallel with said first web server and having an input and an output, wherein said second web server allows
wherein the inputs of said first and second web servers are connected, via a second switch, to the output of said first firewall, wherein said firewall is designed to relay only data packets which are intended and authorized to reach said first and second web servers,
f) a first database having an input and an output, wherein the input is connected, via a third switch, to the outputs of said first and second web servers, wherein said first database stores a collection of data used in operating said PBM, and
g) a PBM software program written to control the operation of said PBM.

5. The PBM as specified in claim 4 further comprising:
a) a second database connected in parallel with said first database and having an input and an output, wherein the inputs of said first and second databases are connected, via said third switch, to the outputs of said first and second web servers, and
b) a database storage connected to said first and second databases.

6. The PBM as specified in claim 5 further comprising a web data storage connected via said third switch to said first and second web servers.

7. The PBM as specified in claim 6 further comprising a remote corporate site having a second firewall connected to second router, wherein said second router is connected via a telephone line or an RF data link to a third router connected said third switch.

8. The PBM as specified in claim 4 wherein said software program is comprised of the following passive and interactive modules:
a) a real-time marketing offer based on a survey response, wherein the offer is sent as an e-mail to the user,
b) a real-time marketing offer based on a survey response, wherein the offer is sent to the user via a first pop-up,
c) a real-time marketing offer based on a survey response, wherein the offer is sent to the user via a flash/HTML,
d) a real-time marketing offer based on a survey response, wherein the offer is sent to the user via a banner,
e) a first survey procedure utilizing a sequential, drill-down group survey,
f) a second survey procedure utilizing a sequential, general non-group survey, and
g) a third survey procedure utilizing a non-sequential drill-down group survey.

9. An Internet-based promotional business model (PBM) comprising:
a) a subnet A comprising a redundant internet data center having means for linking individual computers with various data and promotional messages,
b) a subnet B comprising a first switch and a redundant second switch which are connected respectively to a first firewall and a redundant second firewall, wherein said firewalls are connected respectively to a first cache server and a redundant second cache server, the two cache servers are connected respectively through a second switch and a redundant third switch to a first router and a redundant second router from where said routers are connected to said subnet A,
c) a subnet C comprising a first load balancer and a redundant second load balancer wherein the two load balancers are connected to subnet B via said first and second switches, and respectively to a web server farm and a mail server farm via a fourth switch and a fifth switch, wherein said fourth and fifth switches can connect said web and mail server inline, with said load balancer or reverse the connections to said load balancers,
d) a subnet D comprising a sixth switch and a redundant seventh switch, wherein one side of said switches connects said subnet D to subnet C and the other side of said sixth and seventh switches are connected to a web/E mail mass data storage, wherein either of said two switches can be used to control the operation of said web/E mail mass data storage,
e) a subnet E comprising a clustered database farm controlled by either of said sixth switch or said seventh switch, and
f) a software program written to control the operation of said PBM.

10. The PBM as specified in claim 9 further comprising a mass data storage connected to said clustered database farm.

11. The PBM as specified in claim 9 wherein said redundant Internet data center is comprised of a fully meshed gigabit Ethernet network, wherein the Ethernet provides two 100 megabits per second (mbps) Ethernet connection to an Exodus backbone.

12. The PBM as specified in claim 9 wherein said subnets A-E function in combination to separate the various elements of the architecture into publically accessible and privately accessible elements..

13. The PBM as specified in claim 9 further comprising a mass data storage connected to said clustered database farm.

14. The PBM as specified in claim 9 further comprising a remote corporate site having a firewall connected to a second router, wherein the second router is connected via a telephone line or an RF data link to a third router connected to said subnet D.

15. A process for participating in an Internet-based promotional business model comprising the following steps:
a) log onto a web site which produces three web pages in sequence,
b) select from a first web page a set of numbers or utilize a “quick pick”, and a single category banner,
c) select from a second web page an advertising banner pertaining to the category banner selected in step b), wherein after the advertising banner is selected a third web page appears which:
(1) displays the set of numbers selected in step b) and whether the numbers selected have won a prize,
(2) displays a splash page showing details of the advertising banner selected in step c), and
d) review the contents of the splash page and either press a reply button or log off the web site.

16. A process for participating in an Internet-based promotional business model comprising the following steps:
a) log onto a web site which produces four web pages in sequence,
b) select from a first web page a first set of numbers or a “quick pick”, and a single category banner,
c) select from a second web page a second set of numbers or a “quick pick”, and a first refinement category banner pertaining to the category banner selected in step b),
d) select from a third web page a third set of numbers or a “quick pick”, and a second refinement category banner pertaining to the first refinement category banner selected in step c), at this point the participant is subsequently notified if any of the numbers selected have won a prize and a fourth web page is displayed which shows details of the second refinement category banner selected, and
e) review the contents of the fourth web page and either press a replay button or log off the web site.
